(19) United States
(12) Patent Application Publication
(10) Pub. No.: US 2010/0032523 A1
(43) Pub. Date: Feb. 11, 2010

(54) AIRCRAFT FUSELAGE MADE FROM LONGITUDINAL PANELS AND METHOD OF PRODUCING SUCH A FUSELAGE

(75) Inventors: Guillaume Gallant, Plaisance Du Touch (FR); Philippe Bernadet, Colomiers (FR)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(73) Assignee: Airbus France, Toulouse (FR)

(21) Appl. No.: 12/444,972

(22) PCT Filed: Oct. 4, 2007
(86) PCT No.: PCT/FR07/52081

§ 371 Date: Jul. 22, 2009

(30) Foreign Application Priority Data
Oct. 10, 2006 (FR) 0654185

(51) Int. Cl. B64C 1/00

(52) U.S. Cl. 244/120

(57) ABSTRACT

The invention relates to an aircraft fuselage comprising a nose cone, a tail section and a central section, the central section comprising longitudinal panels assembled directly with one another, at least one of these longitudinal panels having a length corresponding to the distance between the nose cone and the tail section in order to connect said nose cone with said tail section.

### RELATED APPLICATIONS

The present application is a national stage entry of PCT Application No. PCT/FR2007/052081, filed Oct. 4, 2007, which claims priority from French Application No. 0654185, filed Oct. 10, 2006, the disclosures of which are hereby incorporated by reference in their entirety.

### FIELD OF THE INVENTION

The invention concerns an aircraft fuselage whose central section is produced using longitudinal panels that are assembled directly with one another without circumferential joints. It also concerns a method for producing this type of fuselage. The invention has applications in the aeronautics field and, in particular, in the field of manufacturing aircraft fuselages.

### BACKGROUND

Aircraft fuselages, particularly aircraft dedicated to transporting passengers or cargo, are generally made from several metal panels assembled together. These metal panels are often aluminum panels. They are attached to one another by means of circumferential and longitudinal joints. These panels are assembled so that they form fuselage sections, which are themselves assembled to form the fuselage.

As shown in FIG. 1, an aircraft fuselage comprises several sections, namely the front section 1, or nose cone, which comprises the cockpit; the rear section or tail cone generally comprising the tail assembly; and the central section, which is the part of the fuselage that connects the nose cone 1 with the tail section 2. The central section 3 generally includes the passenger cabin and the baggage hold, for passenger transport, or the cargo hold, for cargo transport. The central section is made of several section components or section parts assembled together to form the central section connecting the nose cone with the tail section of the aircraft. At present, each part of the central section 3, for example parts 3a, 3b, 3c and 3d of the fuselage represented in FIG. 1, is produced separately from several metal panels.

FIG. 2 shows an example of two parts of a central section 3 as produced in the traditional manner. Each of these parts 3a and 3b comprises several metal panels assembled together. For example, section part 3a comprises panels 41 to 46 and section part 3b comprises panels 47 to 52. The different panels of a same section part are assembled using longitudinal joints. A “longitudinal joint” is a type of attachment that includes placing the panels so that two consecutive panels partially overlap and inserting fasteners, such as rivets, in the areas where the panels are superimposed.

The central section parts are then assembled together. Two consecutive section parts are assembled by means of circumferential joints. “Circumferential joints” are means of attachment making it possible to assemble section parts over the entire circumference of the parts. Effectively, two section parts cannot be assembled directly to one another (via overlapping) for tolerance reasons, for it is impossible to make two section parts so that they fit into one another perfectly. So, to assemble two section parts, a ferrule is generally placed between the two section parts. A ferrule is a local skin, internal to the section, that reinforces the junction zone of the two section parts. It makes it possible to transfer the stresses from one section to the other. This ferrule is attached on either side to each section part. In other words, an additional skin (made from a single or several pieces of skin mounted on a frame) is placed at the junction of two section parts and attached with fasteners, such as joint bars, onto each of the section parts.

Assembly of the different parts of the central section thus requires the addition of additional skins and of various fastening components to attach these additional skins to the metal panels. These skins and these fasteners, which are generally made of metal, are all parts that increase the weight of the aircraft.

Additionally, producing a central section from so many panels assembled one by one is a relatively lengthy process. The assembly of these numerous panels is therefore an important factor in how long it takes to produce an aircraft fuselage.

With the arrival of composite materials in the field of aeronautics, aircraft manufacturers are attempting to produce a maximum number of fuselage components from composite materials. Composite materials have the advantage of being relatively light compared to metal, which makes it possible to lighten the total weight of an aircraft considerably. To do this, aircraft manufacturers generally try to make the central section from a composite material. They thus seek to reproduce a single skin that would encompass the entire circumference of the central section, i.e., 360°. In other words, they are trying to produce a central section made of a single piece. Since it is difficult to produce this type of central section, section parts consisting of a single part are assembled together to form a central section. Each section part is therefore a cylinder that must then be assembled with the consecutive section parts. This assembly is done using circumferential joints, as described previously, and for which the additional skins are made of a composite material.

An example of this method of producing a fuselage made of composite material is described in patent application PCT WO 2006/001860.

Now, as explained earlier, circumferential joints are costly in terms of weight. Additionally, they require relatively lengthy assembly time, especially since they present assembly problems since the aerodynamic profile requires a perfect adjustment of the different section parts and an adjustment of the contact area of the substructure if the substructure components are mounted in the section parts. Furthermore, in addition to the circumferential joints, numerous interface parts are necessary to attach the additional skin to the two section parts.

Furthermore, given the fact that the current central section is cut up into different section parts, an aircraft fuselage is transported from one site to another section part by section part. In other words, each section part is transported individually on an appropriate transport vehicle.

### SUMMARY

The invention seeks to eliminate the disadvantages of the techniques described earlier. To this end, embodiments of the invention concern an aircraft fuselage whose central segment is made of longitudinal panels assembled directly with one another, that is without additional skins. Thus, the central section does not require the use of circumferential joints over its entire circumference. The invention thus offers gains in terms of the total weight of the fuselage. Furthermore, assembly of the panels via longitudinal joints is simpler than via circumferential joints, which means production is faster.

More specifically, embodiments of the invention concern an aircraft fuselage comprising a nose cone, a tail section and a central section, wherein the central section comprises longitudinal panels assembled directly with one another, at least one of these longitudinal panels having a length corresponding to the distance between the nose cone and the tail section to connect this nose cone with this tail section.

The invention may also comprise one or more of the following features: the longitudinal panels are made of composite materials; the direct assembly of a first panel with a second panel includes a partial superimposition of the first and the second panels and fasteners passing through these panels; one longitudinal panel has a length corresponding to the distance between the nose cone and a central wing box of the aircraft; one longitudinal panel has a length corresponding to the distance between a central wing box of the aircraft and the tail section; one longitudinal panel has a length corresponding to a width of a central wing box; one longitudinal panel incorporates a stiffening sub-structure or a floor structure; one longitudinal panel incorporates skin reinforcements; one longitudinal panel corresponds to an area of the fuselage with single curvature; and one longitudinal panel corresponds to an area of the fuselage with double curvature.

The invention also concerns a method for producing this type of fuselage. Embodiments of the method include the production of a nose cone, a tail section and a central section. Production of the central section includes production of longitudinal panels, at least one of these longitudinal panels having a length corresponding to the distance between the nose cone and the tail section; and assembly of these longitudinal panels directly with one another.

The method of the invention may also include one or more of the following features: the longitudinal panels are made of composite materials; and direct assembly of a first panel with a second panel consists in partially superimposing the first and the second panels and in attaching the two panels by means of fasteners.

The invention also concerns an aircraft comprising a fuselage as described previously. It also concerns an aircraft comprising a fuselage produced according to the method as described previously.

### BRIEF DESCRIPTION OF THE DRAWINGS

FIG. 1, already described, depicts an example of a conventional aircraft fuselage composed of several sections.

FIG. 2, already described, depicts an example of conventional central section parts.

FIG. 3 depicts an example of a central section according to an embodiment of the invention.

FIG. 4 depicts another example of a central section according to an embodiment of the invention.

FIG. 5 depicts an example of a central section with single curvature and a tail section with double curvature, according to an embodiment of the invention.

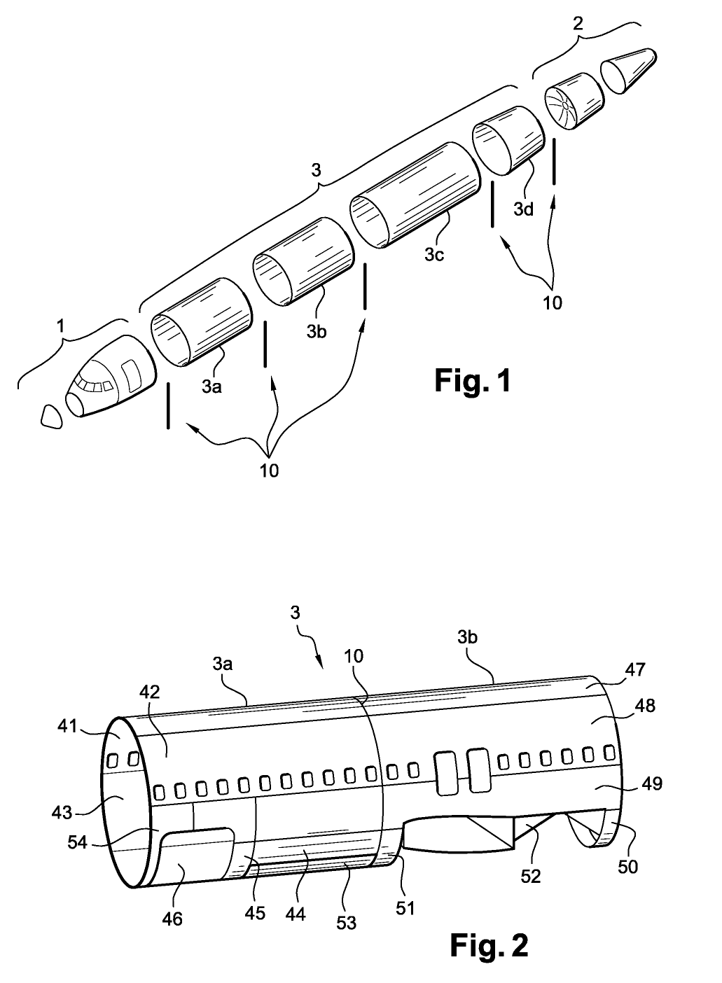

### DETAILED DESCRIPTION

The invention proposes producing the central section of an aircraft from longitudinal panels, that is, very long panels each made of a single piece. In one embodiment, the dimension of each of these longitudinal panels corresponds, at a maximum, to the distance between the nose cone of the aircraft and the tail section of the aircraft and, at a minimum, to the distance between the nose cone of the aircraft and the central wing box or between the tail section of the aircraft and the central wing box. It is understood that other panels may be mounted between very long panels, like, for example, a panel whose length corresponds to the width of the central wing box. At least one longitudinal panel connects the nose cone of the aircraft with the tail section of this aircraft.

Producing a central section of the fuselage from several longitudinal panels allows easier assembly of the panels with one another. Effectively, the longitudinal panels may be assembled using longitudinal joints, that is, by partially superimposing one panel over another panel and by attaching the two panels to one another by means of fasteners passing through the two panels in the area where they are superimposed or by juxtaposing two panels with an internal lining (ferrule) to ensure continuity.

The two longitudinal panels are assembled directly in one embodiment, without requiring any local reinforcement between the two panels.

According to an embodiment, the panels may be made of composite materials. In fact, composite materials make it possible to produce large dimension parts consisting of a single piece. These parts may be panels whose dimension is chosen based on the aircraft to be built and not based on the technical difficulties inherent in producing this part. If the panels are made of composite materials, the fasteners are known components suited to fastening these materials.

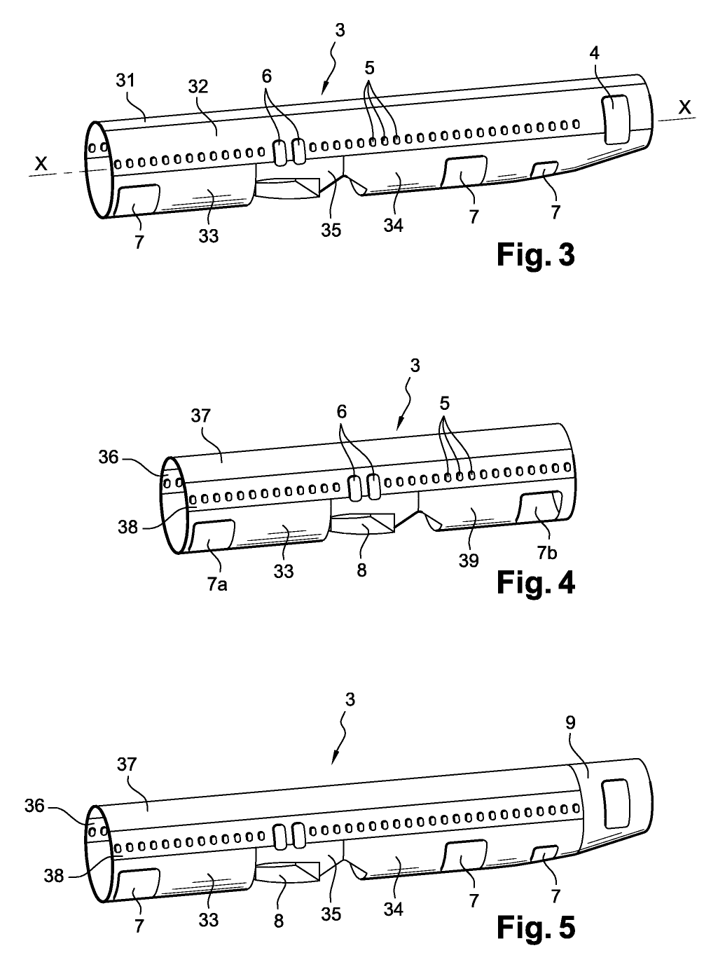

FIG. 3 represents an example of a central fuselage section produced according to the invention. In this example, the central section 3 includes five longitudinal panels 31 to 35, assembled directly with one another. In particular, two panels 31 and 32 are assembled to form the upper part of the fuselage. These are long enough to stretch between the nose cone and the tail cone of the aircraft. The panels 33, 34 and 35 are each attached, on the one hand, to panel 31 and, on the other, to panel 32. The length of panel 33 corresponds to the distance between the nose cone of the aircraft and the central wing box. The length of panel 34 corresponds to the distance between the tail section of the aircraft and the central wing box. The length of panel 35 corresponds to the width of the central wing box.

In one embodiment, assembly is done longitudinally, that is, along the length of the panels. The panels are attached to one another following the longitudinal axis XX of the aircraft. Only certain panels may require partial circumferential assembly in addition to longitudinal assembly. For example, panel 35 must be attached not only to panels 31 and 32 with a longitudinal-type assembly, but also to panels 33 and 34. Assembly of panel 35 with panels 33 and 34 is a partially circumferential or semi-circumferential type assembly. If assembly is not circumferential over the entire circumference of the fuselage, play is possible between the two panels to be assembled.

The panels forming the central section are assembled only via longitudinal joints in one embodiment. No circumferential joints are necessary, except at the front and rear ends of the central section to attach this central section to the nose cone and the tail cone of the aircraft. The total weight of the central section is thus lightened by the weight corresponding to the circumferential joints and other interface parts.

The length of the different longitudinal panels is adapted to the shape of the central section of the aircraft. It may also be adapted to the method for transporting these longitudinal panels. Effectively, the longitudinal panels may be transported in a simpler manner than a conventional central section, for they may be placed one on top of another in the transport vehicle. For example, panels 31 and 32 of FIG. 3 may be placed inside one at the bottom of the vehicle, and panels 34, 33 and 35 may be placed inside one another above panels 31 and 32. Transporting fuselage components in the form of longitudinal panels allows better use of the available loading space. It is also possible to transport several central sections broken down into long panels in a space where it would only be possible to transport a single section if this section were cut up into sections.

Furthermore, assembly of the different longitudinal panels by overlapping these panels is simplified, for the number of fasteners is reduced by more than half. Additionally, as explained previously, longitudinal joints are more tolerant than circumferential joints; the circumferential assembly of two section parts implies that the dimensions of these two section parts are virtually identical to allow continuity in the fuselage, while this constraint does not exist with longitudinal assembly.

According to embodiments of the invention, the longitudinal panels may include aircraft openings and sub-structures. In the example in FIG. 3, panels 31 and 32 include openings corresponding to the locations of the windows 5 and the passenger doors 4 and 6 of the aircraft. Panels 33 and 34 include openings 7 corresponding to the landing gear compartment doors and to the baggage hold doors. In fact, the known techniques for producing parts made of composite material make it possible to produce a part, particularly a panel, in which openings of predetermined dimensions may be made.

Furthermore, these techniques make it possible to insert one or more components made of composite materials or other materials in a panel made of composite materials. The longitudinal panels may therefore include a stiffening substructure for the aircraft, such as intercostals, frames and doorways or complete floor structures. These different panels may also include skin reinforcements like those located near openings or close to heavily loaded areas of the aircraft.

In other examples of central fuselage sections produced according to embodiments of the invention, the part of the fuselage containing the central wing box (corresponding to panel 35 in FIG. 3) is made in longitudinal panels 31, 32 or in longitudinal panels 33, 34. The central section 3 may then comprise only four longitudinal panels. In these examples, a single, partial circumferential assembly may be sufficient, or even no partial circumferential assembly. All the joints ensuring assembly of the different panels with one another may be longitudinal joints.

We thus understand from reading the preceding description that the shape and number of the longitudinal panels may vary based on different criteria, such as the type of aircraft to be built and the mode of transport planned for these panels. In particular, the length of the panels may vary so as to include or not include certain components of the aircraft. For example, the length of panels 31, 32 and 34 in FIG. 3 may vary so as to include or not include the opening corresponding to the rear door 4. FIG. 4 is an example of a central section produced using five panels and not including the opening for the rear door 4. In this example, one panel 37 forms the roof of the central section, two panels 36 and 38, symmetrical on either side of panel 37, include the openings for the windows 5, a panel 33 includes a baggage hold door 7a and panel 39 includes a baggage hold door 7b, as well as the central wing box 8.

In FIG. 4, the longitudinal panels are intended to form fuselage areas with single curvature. An area with single curvature means an area of the fuselage whose curve radius is identical over the entire length of the area. On the contrary, double curvature means an area of the fuselage whose curve radius differs over the length of the area. For example, the tail section of the aircraft is shaped like a cone. Typically, this cone-shaped area is an area with double curvature. On the contrary, the central part of the central section, which may be cylindrical, bilobal or trilobal, etc., is an area with single curvature. From an industrial standpoint, it is much simpler to produce single curvature panels, particularly from composite materials. Indeed, single curvature panels can be made with a plane surface then shaped during curing or draped with special drape-forming machines, for single curvature areas can be developed, contrary to double curvature areas. On the contrary, double curvature panels must be made using relatively complex machines such as fiber placement machines to obtain a progressive curvature of the panel that conforms to the desired shape of the central section. Producing single curvature panels therefore requires less costly equipment than producing double curvature panels. Furthermore, single curvature panels can be assembled by sliding the panels over one another, while assembling double curvature panels requires specific hollowing of the panels between one another, which involves redundancy problems.

For these reasons, the invention proposes a production method in which the longitudinal panels are used only in single curvature areas of the fuselage. It is thus possible to reduce the cost of manufacturing these panels and to reduce the constraints of positioning panels between them. As shown in the example in FIG. 5, this production method proposes producing the double curvature area of the fuselage separately from the single curvature central section. The part of the fuselage represented in FIG. 5 is a double curvature area. In the center of the central section 3, the curve radius is greater than that of section 9. To avoid producing longitudinal panels for double curvature areas, section 9 may be produced independently. Section 9 is then considered as forming the tail section of the aircraft. Longitudinal panels 36, 37, 38, 33, 35 and 34 are thus made for use only in single curvature areas of the fuselage. In this example, section 9 may be produced in traditional fashion, that is, in the form of a 360° section attached to the rest of the central section by a standard circumferential joint.

1. An aircraft fuselage comprising:
a nose cone;
a tail section; and
a central section comprising longitudinal panels made of composite materials and assembled directly with one another by longitudinal joints, at least one longitudinal panel having a length corresponding to a distance between the nose cone and the tail section to couple the nose cone with the tail section.

2. The aircraft fuselage as claimed in claim 1, wherein direct assembly of a first longitudinal panel with a second longitudinal panel includes a partial superimposition of the first and the second longitudinal panels and fasteners passing through the first and second longitudinal panels.

3. The aircraft fuselage as claimed in claim 1, wherein direct assembly of a first longitudinal panel with a second longitudinal panel includes a juxtaposition of the first and second longitudinal panels with an internal lining.

4. The aircraft fuselage as claimed in claim 1, wherein at least one longitudinal panel has a length corresponding to a distance between the nose cone and a central wing box of an aircraft.

5. The aircraft fuselage as claimed in claim 1, wherein at least one longitudinal panel has a length corresponding to a distance between a central wing box and the tail section.

6. The aircraft fuselage as claimed in claim 1, wherein at least one longitudinal panel has a length corresponding to a width of a central wing box.

7. The aircraft fuselage as claimed in claim 1, wherein at least one longitudinal panel comprises at least one of a stiffening sub-structure or a floor structure.

8. The aircraft fuselage as claimed in claim 1, wherein at least one longitudinal panel comprises skin reinforcements.

9. The aircraft fuselage as claimed in claim 1, wherein at least one longitudinal panel corresponds to a single curvature area of the fuselage.

10. The aircraft fuselage as claimed in claim 1, wherein at least one longitudinal panel corresponds to a double curvature area of the fuselage.

11. A method for producing an aircraft fuselage including a nose cone, a tail section and a central section of an aircraft, wherein producing the central section comprises:
producing longitudinal panels of composite materials, at least one of the longitudinal panels having a length corresponding to a distance between the nose cone and the tail section; and
assembling the longitudinal panels directly with one another by longitudinal joints.

12. The method as claimed in claim 11, wherein direct assembly of a first longitudinal panel with a second longitudinal panel comprises partially superimposing the first and the second longitudinal panels and attaching the first and second longitudinal panels by fasteners.

13. The method as claimed in claim 11, wherein direct assembly of a first longitudinal panel with a second longitudinal panel comprises juxtaposing the first and second longitudinal panels with an internal lining.

14. An aircraft comprising:
a fuselage comprising
a nose cone;
a tail section; and
a central section comprising longitudinal panels made of composite materials and assembled directly with one another by longitudinal joints, at least one longitudinal panel having a length corresponding to a distance between the nose cone and the tail section to couple the nose cone with the tail section.

15. An aircraft comprising:
a fuselage comprising a nose cone, a tail section, and a central section, the central section produced by producing longitudinal panels of composite materials, at least one of the longitudinal panels having a length corresponding to a distance between the nose cone and the tail section, and assembling the longitudinal panels directly with one another by longitudinal joints.
